(19) United States
(12) Patent Application Publication
(10) Pub. No.: US 2026/0270881 A1
(43) Pub. Date: Sep. 10, 2026

(54) Configuration of Energy Harvesting Devices

(71) Applicant: Telefonaktiebolaget LM Ericsson (publ), Stockholm (SE)

(72) Inventors: Magnus Åström, Lund (SE); Sina Maleki, Stockholm (SE); Johan Nilsson, Höllviken (SE)

(21) Appl. No.: 19/165,307

(22) PCT Filed: Mar. 27, 2023
(86) PCT No.: PCT/EP2023/057805

§ 371 Date: Sep. 15, 2025

(51) Int. Cl. H04W 52/02; H02J 50/00; H04W 8/20

(52) U.S. Cl. CPC H04W 52/0258; H02J 50/001; H04W 8/205

(57) ABSTRACT

A method, system and apparatus are disclosed. A method implemented in a wireless device configured to communicate with a network node is provided. The method includes selecting a first energy profile of the wireless device, transmitting to the network node a first indication indicating the first energy profile, receiving a first energy configuration from the network node, where the first energy configuration is received in response to the first indication indicating the first energy profile, updating at least one wireless device activity in response to the received first energy configuration, and communicating with the network node in response to the updated at least one wireless device activity.

### TECHNICAL FIELD

The present disclosure relates to wireless communications, and in particular, to configuration of energy harvesting devices in a wireless communication network.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between wireless devices. 3GPP is also working on Sixth Generation (6G) wireless communication systems.

### Internet of Things (IoT)

In the coming years, billions of IoT devices are expected to be connected through wireless networks, hence enabling what some have referred to as the “Fourth Industrial Revolution” or the “Internet of Things” era. The majority of such IoT devices are expected to be sensors that measure and collect data and transmit the results to another location using wireless connections. Such sensing systems may be connected using traditional wireless networks or short-range connections. The sensors and data collection may be integrated using cloud technologies. Some examples of such sensing systems may be groups of temperature or humidity sensors, remote camera surveillance and movement detection systems, etc. Although there are a wide variety of applications for IoT devices, some features are likely to be common for a great many of them.

### Energy Consumption

Device energy consumption is one challenge that is vital for the enablement and success of IoT. Ten years' longevity is a typical timeframe adopted by the industry. In some industries, the “buried-and-forgotten” scenario is preferred and, in such a case, a requirement of a lifetime of thirty years may be expected. This requires great resource frugality both in the communications modules as well as in the sensor or actuator modules of the devices. Hence, a great deal of work is put into defining communication protocols allowing operation with extended transmission/reception intervals, poor synchronization, low signal amplitudes, etc. In general, sensor transceiver design often targets operation at low link quality and at a low expended device energy cost.

### Energy Harvesting

To extend the life of IoT device units, where changing the battery is not reasonably feasible, e.g., due to physical access limitations or the sheer number of units, certain types of device units may be powered by energy harvesting units. For example, some energy harvesting units may be configured for extracting energy from vibration, other mechanical movement, solar radiation, radio frequency (RF) signals in the environment, thermocouples, etc.

Depending on the type of harvesting approach, energy may not be provided to the device unit continuously. Instead, energy is replenished or boosted when, e.g., movement occurs, or sunlight is available. Some device units operate only while the energy source is active. Other units incorporate small rechargeable batteries or capacitors to store the generated energy and use it between the energy boosts.

Existing systems, however, may lack adequate communication protocols and configurations for supporting energy harvesting devices.

### SUMMARY

Existing systems do not consider the special and very different needs that energy harvesting (and/or zero-power/zero-energy/net-zero-power/low-power/IoT) wireless devices may have, i.e., a limited amount of available energy at each instant (in turn implying a limited communication ability). As a result, the energy harvesting device may not communicate efficiently with a network node, or may not be able to communicate with the same capability as a non-energy-harvesting device. Examples of problems that may arise include a failure to perform initial access or network synchronization in a standard manner, a failure to perform retransmissions in case of packet loss, a failure to transmit or receive amounts of data (e.g., failure to receive an amount of data which is larger or smaller than a threshold amount), a failure to perform measurements adhering to a standard procedure, being completely out-of-service for a longer or shorter period of time, which all may be caused by power/energy properties of the wireless device being unknown to the network. From the network perspective, this, in turn, implies inefficient network utilization, because resources (e.g., resources assigned to an energy harvesting wireless device which is unable to utilize the assigned resources due to an energy harvesting-related constraint) may go unused. Hence, there is a need for signaling such that the network node may be informed of the energy harvesting and consumption profile of the wireless device and the wireless device may be configured to communicate with the network node in accordance with its provided energy profile.

Some embodiments thus advantageously provide methods, systems, and apparatuses for configuration of energy harvesting devices in a wireless communication network. Some embodiments of the present disclosure provide a method for providing information about energy harvesting and consumption for an energy harvesting device to a wireless network such that the network node does not configure, schedule, or expect behavior of the wireless device which would exceed the harvesting/communication/etc. capabilities of the device.

Energy harvesting capabilities may be different in different situations and scenarios. If a wireless device is not able to harvest enough energy before the network node tries to schedule the wireless device, then the wireless device may not be able to respond since it does not have enough energy to perform a complete transmission. Thus, in some embodiments of the present disclosure, the wireless device is configured to determine harvesting characteristics/profiles/etc., such as how much power is the wireless device able to preserve, what kind of power consumption profile the wireless device has for various transmissions, etc. In some embodiments, the wireless device and the network node share this information, e.g., as the network node is configuring the device, during an initial connection/reconnection/handoff procedure, etc. Thus, in some embodiments, a capability report and/or semi-static configuration/capability/indication/etc. is provided to the network node from the wireless device, once or periodically, or upon a change in a state/configuration (e.g., change of cell, of serving node, of connection state, etc.), and the network node may take this information into account when scheduling the wireless device. For example, if the wireless device is an energy harvesting device which harvests vibrational energy, and the wireless device is located on a vehicle which is traveling on a bumpy road which generates a high amount of vibrations, the wireless device may be able to communicate more often than when the vehicle is traveling on a smooth road which generates fewer vibrations and thus less energy for harvesting. Thus, in some embodiments, the wireless device may identify/determine/associate energy harvesting opportunities based on communications/configurations/indications/etc. that the network node provides.

In some embodiments, the energy harvesting wireless device first determines an energy harvesting profile and/or energy consumption profile of the energy harvesting device and provides it to the network node. The energy harvesting capability of the wireless device may change over time and/or location, for example, temporary availability or non-availability of mechanical vibrations to harvest, availability of sunlight during different hours of the day, during different periods/seasons of the year, depending on current weather conditions, depending on where the wireless device is located (indoors/outdoors/etc.), etc. This information may be determined by the wireless device and signaled to the network node, and/or may be determined by the network node, and may be utilized by the network node in selecting a configuration for the wireless device and configuring/supporting/optimizing/updating the wireless device functionality (e.g., energy harvesting activities/procedures, wireless communication activities/procedures, etc.). In a second step, the wireless device receives configuration information from the network node and performs wireless device activities/functionalities/procedures, such as communicating with the network node according to the received configuration, harvesting energy according to the configuration, etc.

In some embodiments, a network node may first receive an energy harvesting profile and/or energy consumption profile of the energy harvesting wireless device and from that determine a configuration (i.e., energy harvesting configuration) of the wireless device. The determined configuration is then provided to the wireless device, whereupon the network node starts to communicate with the wireless device according to the determined configuration.

If conditions for energy harvesting change, the energy configuration of the wireless device may be updated to account for the changed conditions. In some embodiments, such an update may be initiated from either the network node, the wireless device, a remote cloud server/host computer, another network entity (e.g., another wireless device, another energy harvesting device, etc.), and/or a third party. Certain conditions, such as a change in weather conditions may, for example, be known to multiple entities, such as one or more of the network node, cloud server, wireless device, etc. Other conditions, such as a temporary inability to harvest energy, may only be known by the wireless device (until the wireless device informs other entities of the conditions). For example, a temporary shadowing of a solar cell powering the wireless device may only be known (initially) by the wireless device, and is an example of a condition which cannot be predicted/determined by the network node without receiving signaling from the wireless device indicating (e.g., explicitly and/or implicitly) the condition (e.g., indicating the temporary shadowing, indicating a reduction in energy harvesting rate, etc.).

According to a first aspect of the present disclosure, a method implemented in a wireless device configured to communicate with a network node is provided. The method includes selecting a first energy profile of the wireless device, transmitting to the network node a first indication indicating the first energy profile, receiving a first energy configuration from the network node, where the first energy configuration is received in response to the first indication indicating the first energy profile, updating at least one wireless device activity in response to the received first energy configuration, and communicating with the network node in response to the updated at least one wireless device activity.

According to one or more embodiments of this aspect, the at least one wireless device activity includes one or more of an initial access procedure, a network synchronization procedure, a cell reselection procedure, a beamforming procedure, a data transmission procedure, a data reception procedure, a measurement procedure, a sleep procedure, a discontinuous reception procedure, a state transition procedure, and a sensor procedure. According to one or more embodiments of this aspect, the first energy profile includes an energy harvesting profile, where the energy harvesting profile indicates one or more of an energy harvesting source type of the wireless device, an energy harvesting rate of the wireless device, an energy harvesting schedule of the wireless device, an energy harvesting time duration of the wireless device, an energy storage amount of the wireless device, and an energy storage capacity of the wireless device. According to one or more embodiments of this aspect, the first energy profile includes an energy consumption profile, and the energy consumption profile indicates a mapping of the at least one wireless device activity to at least one corresponding energy consumption rate. The updating of the at least one wireless device activity is performed in reaction to the at least one corresponding energy consumption rate. According to one or more embodiments of this aspect, the updating of the at least one wireless device activity is performed in reaction to at least one channel condition associated with the wireless device.

According to one or more embodiments of this aspect, the updating of the at least one wireless device activity includes restricting at least one of transmissions and receptions of at least one non-essential transmission type during at least one time period, where the at least one time period is associated with a low energy harvesting rate of the wireless device. According to one or more embodiments of this aspect, the updating of the at least one wireless device activity includes scheduling transitions between a sleep state and an active state of the wireless device in reaction to a predicted energy harvesting rate of the wireless device. According to one or more embodiments of this aspect, the predicted energy harvesting rate of the wireless device is dependent on weather information associated with a location of the wireless device. According to one or more embodiments of this aspect, the first energy configuration indicates at least one of a communication bandwidth, a scheduling periodicity, a packet size, a discontinuous reception periodicity, and a measurement periodicity. According to one or more embodiments of this aspect, the method further includes detecting a change of an energy state of the wireless device, updating an energy profile in response to the detected change of the at least one energy state, transmitting to the network node a second indication indicating the updated energy profile, where the updated energy profile is different from the first energy profile, receiving an updated energy configuration from the network node in response to the updated energy profile, and modifying at least one of the at least one wireless device activities in response to the updated energy configuration.

According to one or more embodiments of this aspect, the transmission of the first indication indicating the first energy profile includes at least one energy harvesting type indication and at least one energy harvesting rate indication, where the at least one energy harvesting rate indication is associated with one of the at least one energy harvesting type indication. The energy harvesting type indication may be transmitted via higher layer signaling, while the energy harvesting rate indication may be transmitted via lower layer signaling. According to one or more embodiments of this aspect, the method further includes selecting at least one updated energy harvesting rate associated with at least one energy harvesting type, and transmitting a second indication to the network node, where the second indication indicates the at least one updated energy harvesting rate. The energy configuration may, for example, indicate at least one energy harvesting type, and the method may further include performing harvesting of energy according to the indicated at least one energy harvesting type. According to one or more embodiments of this aspect, the energy profile indicates a malfunctioning energy harvesting type and at least one non-malfunctioning energy harvesting type.

According to another aspect of the present disclosure, a method implemented in a network node configured to communicate with a wireless device is provided. The method includes receiving, from the wireless device, a first indication indicating a first energy profile of the wireless device. The method further includes selecting a first energy configuration based on the first indication indicating the first energy profile. The method further includes transmitting the energy configuration to the wireless device for updating at least one wireless device in response to the first energy configuration. The method further includes communicating with the wireless device in response to the updated at least one wireless device activity.

According to one or more embodiments of this aspect, the updating of the at least one wireless device activity is further performed in response to at least one channel condition associated with the wireless device. According to one or more embodiments of this aspect, the updating of the at least one wireless device activity includes restricting at least one of transmissions and receptions of at least one non-essential transmission type during at least one time period, where the at least one time period is associated with a low energy harvesting rate of the wireless device.

According to one or more embodiments of this aspect, the updating of the at least one wireless device activity includes scheduling transitions between sleep and active states of the wireless device in response to a predicted energy harvesting rate of the wireless device.

According to one or more embodiments of this aspect, the method further includes receiving a second indication indicating an updated energy profile of the wireless device, where the updated energy profile includes at least one parameter different from the first energy profile, selecting an updated energy configuration based on the updated energy profile, and transmitting the updated energy configuration to the wireless device for modifying at least one of the at least one wireless device activities in response to the updated energy configuration received.

According to one or more embodiments of this aspect, receiving the first indication indicating the first energy profile includes at least one energy harvesting type indication, and at least one energy harvesting rate indication received, where each of the at least one energy harvesting rate indication is associated with one of the at least one energy harvesting type indication.

According to one or more embodiments of this aspect, the method further includes receiving a second indication from the wireless device, where the second indication indicates at least one updated energy harvesting rate associated with the at least one energy harvesting, selecting a modified energy configuration in response to the received second indication, and transmitting the modified energy configuration to the wireless device. According to one or more embodiments of this aspect, the energy profile indicates a malfunctioning energy harvesting type and at least one non-malfunctioning energy harvesting type.

According to another aspect of the present disclosure, a wireless device configured to communicate with a network node is provided. The wireless device comprising processing circuitry configured to select a first energy profile of the wireless device, transmit to the network node a first indication indicating the first energy profile, receive a first energy configuration from the network node, where the first energy configuration is received in response to the first indication indicating the first energy profile, update at least one wireless device activity in response to the received first energy configuration, and communicate with the network node in response to the updated at least one wireless device activity.

According to one or more embodiments of this aspect, the at least one wireless device activity includes one or more of an initial access procedure, a network synchronization procedure, a cell reselection procedure, a beamforming procedure, a data transmission procedure, a data reception procedure, a measurement procedure, a sleep procedure, a discontinuous reception procedure, a state transition procedure, and a sensor procedure. According to one or more embodiments of this aspect, the first energy profile includes an energy harvesting profile, and the energy harvesting profile indicates one or more of an energy harvesting source type of the wireless device, an energy harvesting rate of the wireless device, an energy harvesting schedule of the wireless device, an energy harvesting time duration of the wireless device, an energy storage amount of the wireless device, and an energy storage capacity of the wireless device. According to one or more embodiments of this aspect, the first energy profile includes an energy consumption profile, where the energy consumption profile indicates a mapping of the at least one wireless device activity to at least one corresponding energy consumption rate, and the updating of the at least one wireless device activity is performed in reaction to the at least one corresponding energy consumption rate.

According to one or more embodiments of this aspect, the processing circuitry is further configured to detect a change of an energy state of the wireless device, update an energy profile in response to the detected change of the at least one energy state, transmit to the network node a second indication indicating the updated energy profile, where the updated energy profile is different from the first energy profile, receive an updated energy configuration from the network node in response to the updated energy profile, and modify at least one of the at least one wireless device activities in response to the updated energy configuration.

According to one or more embodiments of this aspect, the transmission of the first indication indicating the first energy profile includes at least one energy harvesting type indication, and at least one energy harvesting rate indication transmitted, where the at least one energy harvesting rate indication is associated with one of the at least one energy harvesting type indication. According to one or more embodiments of this aspect, the processing circuitry is further configured to select at least one updated energy harvesting rate associated with at least one energy harvesting type, and transmit a second indication via lower layer signaling to the network node, where the second indication indicates the at least one updated energy harvesting rate. According to one or more embodiments of this aspect, the energy configuration indicates at least one energy harvesting type, and the processing circuitry is further configured to perform harvesting of energy according to the indicated at least one energy harvesting type. According to one or more embodiments of this aspect, the energy profile indicates a malfunctioning energy harvesting type and at least one non-malfunctioning energy harvesting type.

According to another aspect of the present disclosure, a network node configured to communicate with a wireless device is provided. The network node includes processing circuitry configured to receive, from the wireless device, a first indication indicating a first energy profile of the wireless device, select a first energy configuration based on the first indication indicating the first energy profile, transmit the energy configuration to the wireless device for updating at least one wireless device in response to the first energy configuration, and communicate with the wireless device in response to the updated at least one wireless device activity.

According to one or more embodiments of this aspect, the first energy profile includes at least an energy harvesting type indication and at least one energy harvesting rate indication, each of the at least one energy harvesting rate indication being associated with one of the at least one energy harvesting type indication.

According to one or more embodiments of this aspect, the processing circuitry is further configured to receive a second indication from the wireless device, the second indication indicating an updated energy profile of the wireless device, the updated energy profile including at least one updated energy harvesting rate associated with the at least one energy harvesting, select an updated energy configuration in response to the received second indication; and transmit the modified energy configuration to the wireless device.

According to one or more embodiments of this aspect, the energy profile indicates a malfunctioning energy harvesting type and at least one non-malfunctioning energy harvesting type.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for configuration of energy harvesting devices in a wireless communication network according to some embodiments of the present disclosure;

FIG. 8 is a flowchart of an example process in a wireless device for configuration of energy harvesting devices in a wireless communication network according to some embodiments of the present disclosure;

FIG. 9 is a flowchart of another example process in a wireless device for configuration of energy harvesting devices in a wireless communication network according to some embodiments of the present disclosure;

FIG. 10 is a flowchart of another example process in a network node for configuration of energy harvesting devices in a wireless communication network according to some embodiments of the present disclosure;

FIG. 11 a signaling diagram of communication between a between a wireless device and a network node for configuration of energy harvesting devices in a wireless communication network according to some embodiments of the present disclosure; and

FIG. 12 a flowchart of an example process in a system including a wireless device and a network node for configuration of energy harvesting devices in a wireless communication network according to some embodiments of the present disclosure.

### DETAILED DESCRIPTION

Before describing example embodiments in detail, it is noted that the embodiments presented herein are primarily directed to combinations of apparatus components and processing steps related to the configuration of energy harvesting devices in a wireless communication network. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, Minimizing Drive Testing (MDT) node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as an energy harvesting wireless device or a radio network node.

In some embodiments, the non-limiting terms wireless device (WD), user equipment (UE), and energy harvesting device are used interchangeably. The energy harvesting wireless device herein can be any type of wireless device capable of communicating with a network node or another wireless device over radio signals, such as wireless device, and which includes energy harvesting capabilities (e.g., includes a solar panel as part of wireless device hardware) and/or which is configured to receive power/energy from an energy harvesting device (e.g., a separate or separable solar panel device/module is connected to/electrically coupled to the wireless device). The energy harvesting wireless device may also be a radio communication device, target device, device to device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IoT) device, a Narrowband IoT (NB-IoT) device, a net-zero-energy-consumption device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the term “higher layer signaling” may refer to radio resource control (RRC) signaling/messaging, system information broadcast (SIB), OSI, RMSI, SSB, PBCH, non-access stratum (NAS) signaling/messaging, positioning protocol signaling/messaging (e.g., according to the LTE Positioning Protocol (LPP), the New Radio Position Protocol (NPP), etc.), or similar signaling/messaging.

In some embodiments, the term “lower layer signaling” may refer to medium access control (MAC) signaling/messaging/commands, downlink control indicator (DCI) signaling, sidelink control information (SCI) signaling, physical control channel signaling, broadcast channel signaling, Open Systems Interconnection (OSI) layer 1 (L1) signaling, OSI layer 2 (L2) signaling, or similar signaling.

In some embodiments, “higher layer” and “lower layer” may be relative terms, e.g., relative to a particular layer. For example, in some embodiments, “higher layer” may refer to one or more layers above layer 2 (L2) of a 3GPP protocol stack, and “lower layer” refers to layer 1 and layer 2. In other embodiments, other layers (e.g., layer 1, layer 3, etc.) may serve as the boundary between “higher layer” and “lower layer” signaling. What is considered “higher layer” and “lower layer” may be configurable, e.g., by a network node, by a wireless device, by a cloud-based server, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for energy harvesting devices in a wireless communication network.

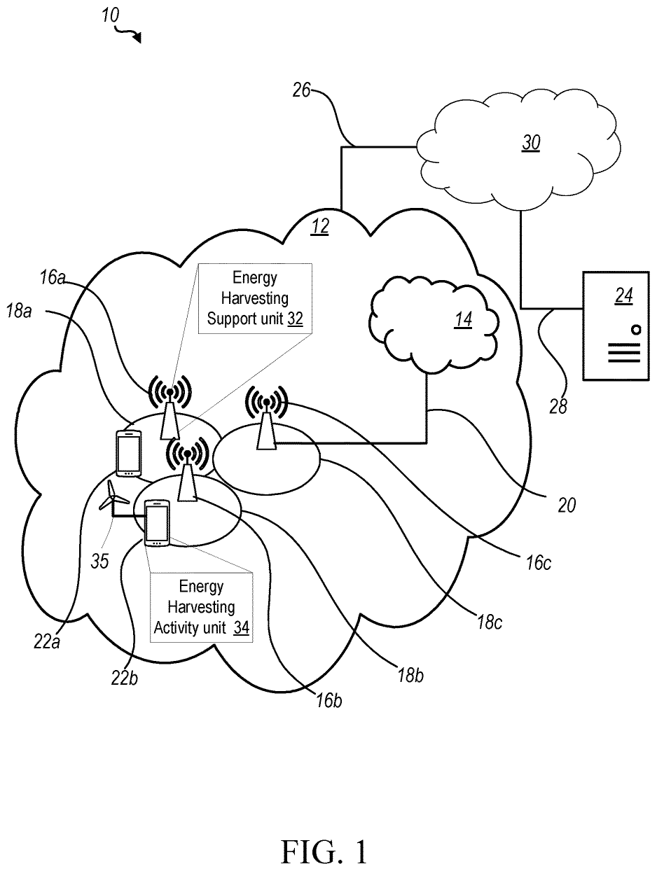

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second wireless device 22b in coverage area 18b is wirelessly connectable to the corresponding network node 16b. While a plurality of wireless devices 22a, 22b (collectively referred to as wireless devices 22) are illustrated in this example, the disclosed embodiments are equally applicable to a situation where a sole wireless device is in the coverage area or where a sole wireless device is connecting to the corresponding network node 16. Note that although only two wireless devices 22 and three network nodes 16 are shown for convenience, the communication system may include many more wireless devices 22 and network nodes 16. One or more wireless devices 22 may be considered an “energy harvesting” wireless device 22, e.g., based on power/energy source, based on an ability to collect and/or receive harvested energy, etc. One or more wireless devices 22 may also be considered an IoT device, a low-power device, a “zero-energy” device (e.g., net-zero energy consumption device, a device which operates with minimal or zero battery power, from a user perspective, and/or derives power primarily from energy harvesting, etc.), a sensor device, etc.

Also, it is contemplated that a wireless device 22 can be in simultaneous communication and/or configured to separately communicate with more than one network node 16 and more than one type of network node 16. For example, a wireless device 22 can have dual connectivity with a network node 16 that supports LTE and the same or a different network node 16 that supports NR. As an example, wireless device 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected wireless devices 22a, 22b and the host computer 24. The connectivity may be described as an over-the-top (OTT) connection. The host computer 24 and the connected wireless devices 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected wireless device 22a. Similarly, the network node 16 need not be aware of the future routing of an outgoing uplink communication originating from the wireless device 22a towards the host computer 24.

A network node 16 is configured to include an Energy Harvesting Support unit 32 which is configured to support and update configurations of energy harvesting devices in a wireless communication network. An energy harvesting wireless device 22 is configured to include an Energy Harvesting Activity unit 34 which is configured to implement energy harvesting configurations and perform wireless device activities in accordance with the energy harvesting configurations. The (energy harvesting) wireless device 22 is configured to include and/or receive harvested energy from energy harvester 35, which may be, for example, one or more of a solar power energy harvester 35, a vibrational energy harvester 35, a temperature gradient energy harvester 35, a wind power energy harvester 35, an RF energy harvester 35, etc.

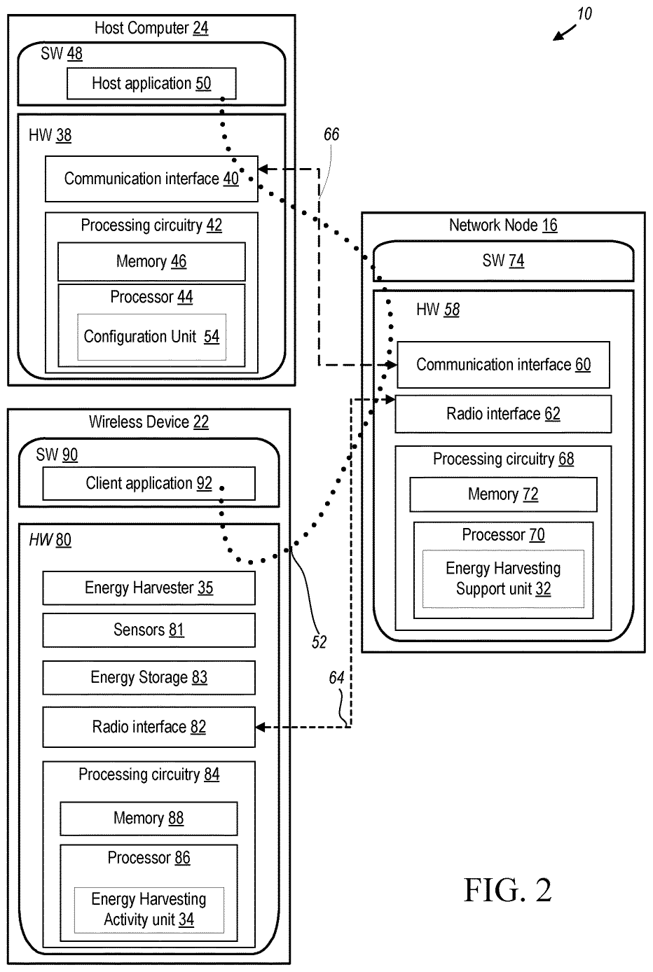

Example implementations, in accordance with an embodiment, of the wireless device 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 may corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a wireless device 22 connecting via an OTT connection 52 terminating at the wireless device 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configuration unit 54 configured to enable the service provider to observe/monitor/control/transmit to/receive from/etc. the network node 16 and or the wireless device 22, for example, for monitoring/adjusting energy harvesting configurations of wireless devices 22 in the network, commanding network nodes 16 to apply/update/support/etc. one or more energy harvesting configurations for wireless devices 22, selecting/defining one or more requirements for energy harvesting/communication/sensor data collection/measurement, etc.

The communication system 10 further includes a network node 16 provided in a communication system 10 and including hardware 58 enabling it to communicate with the host computer 24 and with the wireless device 22. The hardware 58 may include a communication interface 60 for setting up and maintaining a wired or wireless connection with an interface of a different communication device of the communication system 10, as well as a radio interface 62 for setting up and maintaining at least a wireless connection 64 with a wireless device 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 may correspond to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, cause the processor 70 and/or processing circuitry 68 to perform the processes described herein with respect to network node 16. For example, processing circuitry 68 of the network node 16 may include an Energy Harvesting Support unit 32 which is configured to support and update configurations of energy harvesting wireless devices 22 in a wireless communication network.

The communication system 10 further includes the wireless device 22 already referred to. The wireless device 22 may have hardware 80 that may include one or more sensors 81, which may be formed as or may include, for example, one or more actuators, temperature sensors (e.g., thermometer), weather sensors, pressure sensors (e.g., barometer), light/optical sensors, image sensors (e.g., camera), audio sensors (e.g., microphone), motion sensors, level sensors, proximity sensors, water sensors, water quality sensors, air quality sensors, chemical sensors, biometric sensors, gas sensors, smoke sensors, infrared sensors, acceleration sensors, gyroscopic sensors, humidity sensors, etc.

The hardware 80 may further include a radio interface 82 configured to set up and maintain a wireless connection 64 with a network node 16 serving a coverage area 18 in which the wireless device 22 is currently located. The radio interface 82 may be formed as or may include, for example, one or more RF transmitters, one or more RF receivers, and/or one or more RF transceivers.

The hardware 80 of the wireless device 22 may further include energy storage 83, which may be formed as or may include, for example, one or more batteries, capacitors, accumulators, etc.

The hardware 80 of the wireless device 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the wireless device 22 may further comprise software 90, which is stored in, for example, memory 88 at the wireless device 22, or stored in external memory (e.g., database, storage array, network storage device, etc.) accessible by the wireless device 22. The software 90 may be executable by the processing circuitry 84. The software 90 may include a client application 92. The client application 92 may be operable to provide a service to a human or non-human user via the wireless device 22, with the support of the host computer 24. In the host computer 24, an executing host application 50 may communicate with the executing client application 92 via the OTT connection 52 terminating at the wireless device 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by wireless device 22. The processor 86 corresponds to one or more processors 86 for performing wireless device 22 functions described herein. The wireless device 22 includes memory 88 that is configured to store data, programmatic software code and/or other information described herein. In some embodiments, the software 90 and/or the client application 92 may include instructions that, when executed by the processor 86 and/or processing circuitry 84, cause the processor 86 and/or processing circuitry 84 to perform the processes described herein with respect to wireless device 22. For example, the processing circuitry 84 of the wireless device 22 may include an Energy Harvesting Activity unit 34 which is configured to implement energy harvesting configurations and perform wireless device activities in accordance with the energy harvesting configurations.

In some embodiments, the inner workings of the network node 16, wireless device 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the wireless device 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the wireless device 22 and the network node 16 is in accordance with the teachings of the embodiments described throughout this disclosure. One or more of the various embodiments improve the performance of OTT services provided to the wireless device 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and wireless device 22, in response to variations in the measurement results. The measurement procedure and/or the network functionality for reconfiguring the OTT connection 52 may be implemented in the software 48 of the host computer 24 or in the software 90 of the wireless device 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary wireless device signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the wireless device 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the wireless device 22, and/or preparing/terminating/maintaining/supporting/ending in receipt of a transmission from the wireless device 22.

In some embodiments, the host computer 24 includes processing circuitry 42 and a communication interface 40 that is configured to a communication interface 40 configured to receive user data originating from a transmission from a wireless device 22 to a network node 16. In some embodiments, the wireless device 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as Energy Harvesting Support unit 32, and Energy Harvesting Activity unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an example method implemented in a communication system, such as, for example, the communication system of FIGS. 1 and 2, in accordance with one embodiment. The communication system may include a host computer 24, a network node 16 and a wireless device 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the wireless device 22 (Block S104). In an optional third step, the network node 16 transmits to the wireless device 22 the user data which was carried in the transmission that the host computer 24 initiated, in accordance with the teachings of the embodiments described throughout this disclosure (Block S106). In an optional fourth step, the wireless device 22 executes a client application, such as, for example, the client application 92, associated with the host application 50 executed by the host computer 24 (Block S108).

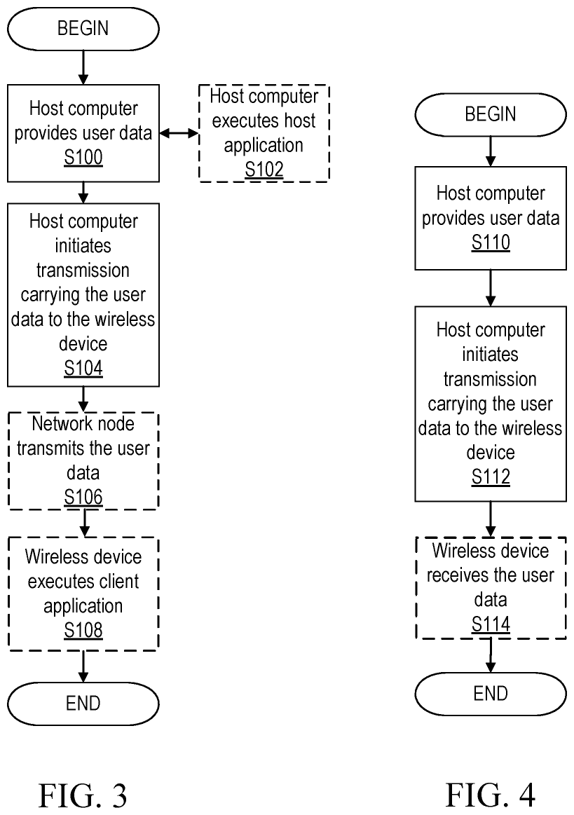

FIG. 4 is a flowchart illustrating an example method implemented in a communication system, such as, for example, the communication system of FIG. 1, in accordance with one embodiment. The communication system may include a host computer 24, a network node 16 and a wireless device 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the wireless device 22 (Block S112). The transmission may pass via the network node 16, in accordance with the teachings of the embodiments described throughout this disclosure. In an optional third step, the wireless device 22 receives the user data carried in the transmission (Block S114).

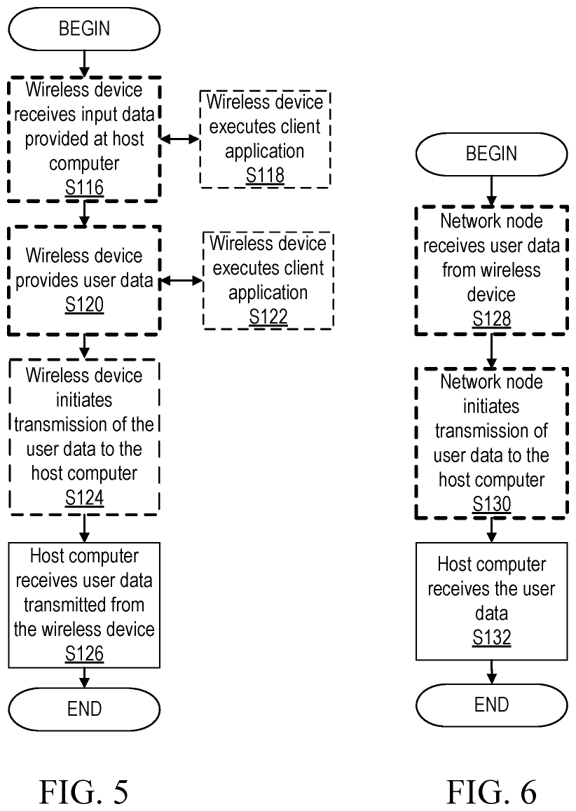

FIG. 5 is a flowchart illustrating an example method implemented in a communication system, such as, for example, the communication system of FIG. 1, in accordance with one embodiment. The communication system may include a host computer 24, a network node 16 and a wireless device 22, which may be those described with reference to FIGS. 1 and 2. In an optional first step of the method, the wireless device 22 receives input data provided by the host computer 24 (Block S116). In an optional substep of the first step, the wireless device 22 executes the client application 92, which provides the user data in reaction to the received input data provided by the host computer 24 (Block S118). Additionally or alternatively, in an optional second step, the wireless device 22 provides user data (Block S120). In an optional substep of the second step, the wireless device provides the user data by executing a client application, such as, for example, client application 92 (Block S122). In providing the user data, the executed client application 92 may further consider user input received from the user. Regardless of the specific manner in which the user data was provided, the wireless device 22 may initiate, in an optional third substep, transmission of the user data to the host computer 24 (Block S124). In a fourth step of the method, the host computer 24 receives the user data transmitted from the wireless device 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a wireless device 22, which may be those described with reference to FIGS. 1 and 2. In an optional first step of the method, in accordance with the teachings of the embodiments described throughout this disclosure, the network node 16 receives user data from the wireless device 22 (Block S128). In an optional second step, the network node 16 initiates transmission of the received user data to the host computer 24 (Block S130). In a third step, the host computer 24 receives the user data carried in the transmission initiated by the network node 16 (Block S132).

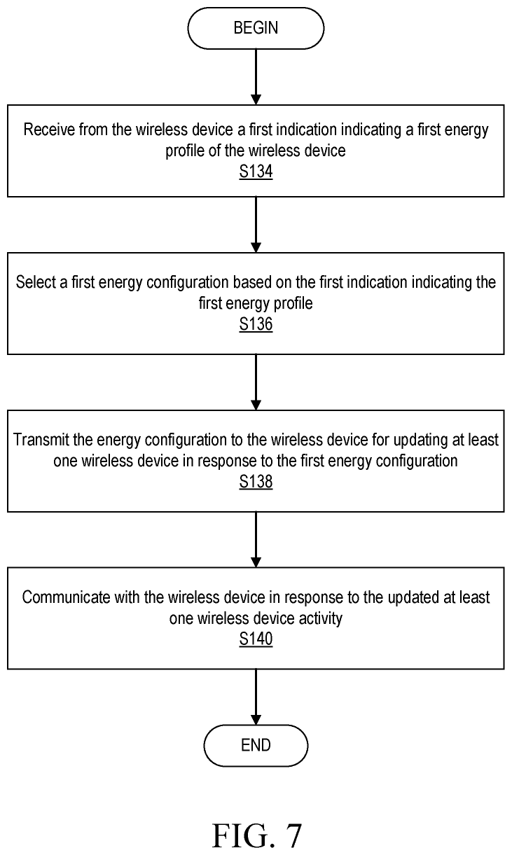

FIG. 7 is a flowchart of an example process in a network node 16 for supporting and updating configurations of energy harvesting devices in a wireless communication network. One or more blocks described herein may be performed by one or more elements of network node 16 such as by one or more of processing circuitry 68 (including the Energy Harvesting Support unit 32), processor 70, radio interface 62 and/or communication interface 60. Network node 16 is configured to receive (Block S134) from the (energy harvesting) wireless device 22 a first indication indicating a first energy profile of the wireless device 22. Network node 16 is configured to select (Block S136) a first energy configuration based on the first indication indicating the first energy profile. Network node 16 is configured to transmit (Block S138) the energy configuration to the wireless device 22 for updating at least one wireless device 22 in response to the first energy configuration. Network node 16 is further configured to communicate (Block S140) with the wireless device 22 in response to the updated at least one wireless device activity.

In some embodiments, the at least one wireless device 22 activity includes at least one of an initial access procedure, a network synchronization procedure, a cell reselection procedure, a beamforming procedure, a data transmission procedure, a data reception procedure, a measurement procedure, a sleep procedure, a discontinuous reception procedure, a state transition procedure, and a sensor procedure. In some embodiments, the first energy profile includes an energy harvesting profile, where the energy harvesting profile indicates at least one of an energy harvesting source type of the wireless device 22, an energy harvesting rate of the wireless device 22, an energy harvesting schedule of the wireless device 22, an energy harvesting time duration of the wireless device 22, an energy storage amount of the wireless device 22, and an energy storage capacity of the wireless device 22. In some embodiments, the first energy profile includes an energy consumption profile, where the energy consumption profile indicates a mapping of the at least one wireless device 22 procedure to at least one corresponding energy consumption rate, and the updating of the at least one wireless device 22 activity is performed in response to the at least one corresponding energy consumption rate. In some embodiments, the updating of the at least one wireless device 22 activity is further performed in response to at least one channel condition associated with the wireless device 22. In some embodiments, the updating of the at least one wireless device 22 activity includes restricting at least one of transmissions and receptions of at least one non-essential transmission type during at least one time period, where the at least one time period is associated with a low energy harvesting rate of the wireless device 22.

In some embodiments, the updating of the at least one wireless device 22 activity includes scheduling transitions between sleep and active states of the wireless device 22 in response to a predicted energy harvesting rate of the wireless device 22. In some embodiments, the predicted energy harvesting rate of the wireless device 22 is dependent on weather information associated to a location of the wireless device 22. In some embodiments, the first energy configuration indicates at least one of a communication bandwidth, a scheduling periodicity, a packet size, a discontinuous reception periodicity, and a measurement periodicity.

In some embodiments, the method further includes receiving a second indication indicating an updated energy profile of the wireless device 22, where the updated energy profile includes at least one parameter different from the first energy profile, selecting an updated energy configuration based on the updated energy profile, and transmitting the updated energy configuration to the wireless device 22 for modifying at least one of the at least one wireless device 22 activities in response to the updated energy configuration received.

In some embodiments, the first indication is transmitted via at least one of radio resource control, RRC, signaling, physical random access channel, PRACH, signaling, Layer 1, L1, signaling, Layer 2, L2, signaling, and physical uplink control channel, PUCCH, signaling. In some embodiments, receiving the first indication indicating the first energy profile includes at least one energy harvesting type indication received via higher layer signaling, and at least one energy harvesting rate indication received via lower layer signaling, where each of the at least one energy harvesting rate indication is associated with one of the at least one energy harvesting type indication.

In some embodiments, the method further includes receiving a second indication via lower layer signaling from the wireless device 22, where the second indication indicates at least one updated energy harvesting rate associated with the at least one energy harvesting, selecting a modified energy configuration in response to the received second indication, and transmitting the modified energy configuration to the wireless device 22. In some embodiments, the energy configuration indicates at least one energy harvesting type, and the at least one wireless device 22 activity includes harvesting energy according to the indicated at least one energy harvesting type. In some embodiments, the energy profile indicates a malfunctioning energy harvesting type and at least one non-malfunctioning energy harvesting type.

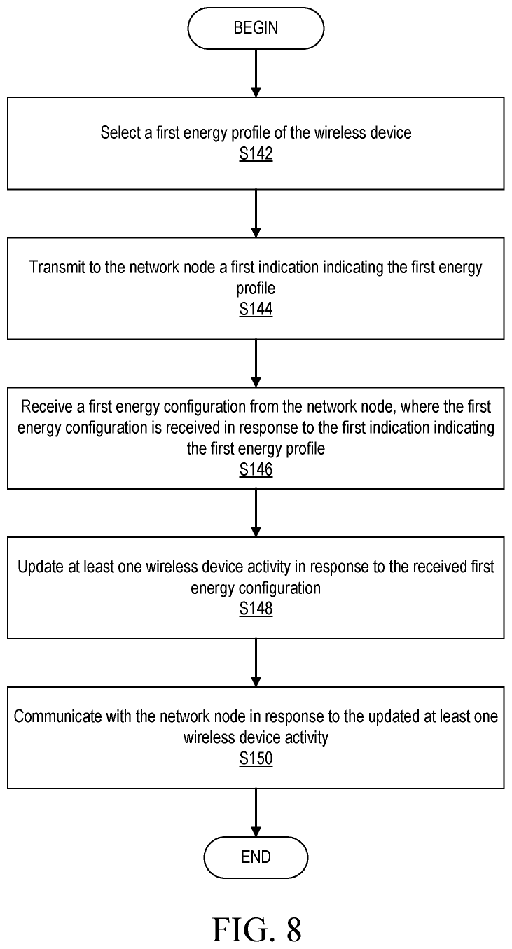

FIG. 8 is a flowchart of an example process in a wireless device 22 (i.e., an energy harvesting wireless device 22) according to some embodiments of the present disclosure for implementing energy harvesting configurations and performing wireless device activities in accordance with the energy harvesting configurations. One or more blocks described herein may be performed by one or more elements of wireless device 22 such as by one or more of processing circuitry 84 (including the Energy Harvesting Activity unit 34), processor 86, sensors 81, energy harvester 35, energy storage 83, radio interface 82 and/or communication interface 60. Wireless device 22 is configured to select (Block S142) a first energy profile of the wireless device 22. Wireless device 22 is configured to transmit (Block S144) to the network node a first indication indicating the first energy profile. Wireless device 22 is configured to receive (Block S146) a first energy configuration from the network node, where the first energy configuration is received in response to the first indication indicating the first energy profile. Wireless device 22 is configured to update (Block S148) at least one wireless device activity in response to the received first energy configuration. Wireless device 22 is configured to communicate (Block S150) with the network node 16 in response to the updated at least one wireless device activity.

In some embodiments, the at least one wireless device 22 activity includes one or more of an initial access procedure, a network synchronization procedure, a cell reselection procedure, a beamforming procedure, a data transmission procedure, a data reception procedure, a measurement procedure, a sleep procedure, a discontinuous reception procedure, a state transition procedure, and a sensor procedure. In some embodiments, the first energy profile includes an energy harvesting profile, where the energy harvesting profile indicates one or more of an energy harvesting source type of the wireless device 22, an energy harvesting rate of the wireless device 22, an energy harvesting schedule of the wireless device 22, an energy harvesting time duration of the wireless device 22, an energy storage amount of the wireless device 22, and an energy storage capacity of the wireless device 22. In some embodiments, the first energy profile includes an energy consumption profile, and the energy consumption profile indicates a mapping of the at least one wireless device 22 activity to at least one corresponding energy consumption rate. The updating of the at least one wireless device 22 activity is performed in reaction to the at least one corresponding energy consumption rate. In some embodiments, the updating of the at least one wireless device 22 activity is performed in reaction to at least one channel condition associated with the wireless device 22.

In some embodiments, the updating of the at least one wireless device 22 activity includes restricting at least one of transmissions and receptions of at least one non-essential transmission type during at least one time period, where the at least one time period is associated with a low energy harvesting rate of the wireless device 22. In some embodiments, the updating of the at least one wireless device 22 activity includes scheduling transitions between a sleep state and an active state of the wireless device 22 in reaction to a predicted energy harvesting rate of the wireless device 22. In some embodiments, the predicted energy harvesting rate of the wireless device 22 is dependent on weather information associated with a location of the wireless device 22. In some embodiments, the first energy configuration indicates at least one of a communication bandwidth, a scheduling periodicity, a packet size, a discontinuous reception periodicity, and a measurement periodicity. In some embodiments, the method further includes detecting a change of an energy state of the wireless device 22, updating an energy profile in response to the detected change of the at least one energy state, transmitting to the network node 16 a second indication indicating the updated energy profile, where the updated energy profile is different from the first energy profile, receiving an updated energy configuration from the network node 16 in response to the updated energy profile, and modifying at least one of the at least one wireless device 22 activities in response to the updated energy configuration.

In some embodiments, the first indication is transmitted via at least one of radio resource control, RRC, signaling, physical random access channel, PRACH, signaling, Layer 1, L1, signaling, Layer 2, L2, signaling, and physical uplink control channel, PUCCH, signaling. In some embodiments, the transmission of the first indication indicating the first energy profile include at least one energy harvesting type indication transmitted via higher layer signaling, and at least one energy harvesting rate indication transmitted via lower layer signaling. The at least one energy harvesting rate indication is associated with one of the at least one energy harvesting type indication. In some embodiments, the method further includes selecting at least one updated energy harvesting rate associated with at least one energy harvesting type, and transmitting a second indication via lower layer signaling to the network node 16, where the second indication indicates the at least one updated energy harvesting rate. In some embodiments, the energy configuration indicates at least one energy harvesting type, and the method further includes performing harvesting of energy according to the indicated at least one energy harvesting type. In some embodiments, the energy profile indicates a malfunctioning energy harvesting type and at least one non-malfunctioning energy harvesting type.

Having described the general process flow of arrangements of the disclosure and having provided examples of hardware and software arrangements for implementing the processes and functions of the disclosure, the sections below provide details and examples of arrangements for configuration of energy harvesting devices in a wireless communication network.

In some embodiments of the present disclosure, a method implemented in an energy harvesting wireless device 22 for communication with a network node 16 in a wireless network is provided. The method includes the wireless device 22 determining an energy profile of the wireless device 22 (e.g., a “savings” profile), signaling the energy profile to the network node 16, receiving a configuration (e.g., an energy harvesting configuration) from the network node 16, and communicating with the network node 16 according to the energy profile/configuration. For example, the communication/configuration may include one or more of a sleep pattern, such as sleeping for a specific number of minutes or seconds, so the wireless device 22 may fill up its energy storage/batteries. As another example, the wireless device 22 may limiting itself to transmitting/receiving/communicating a subset of information/signaling/data/control/etc., e.g., only essential information, because the wireless device 22 is unable to transmit all pending data/control/etc. due to its energy profile not being favorable at the time of the transmission.

In some embodiments, the energy profile includes one or more of an energy harvesting profile and an energy consumption profile. The energy harvesting profile may include, e.g., an amount of energy that is harvested for a given period of time (e.g., an energy harvesting rate, total energy harvested, etc.). The energy consumption profile may include, e.g., an amount of energy (e.g., energy consumption rate, total energy consumption, etc.) that is consumed for a given activity/procedure/etc. The activity may be related to one or more of:
an initial access activity/procedure (e.g., wireless device 22 has been asleep for a long time (e.g., several hours, days, etc.) and needs to perform some actions, such as network synchronization, before connecting to network node 16);
a data transmission procedure;
a data reception procedure;
a cell measurement procedure;
a sleep state/multiple sleep states; and/or
state transitions (e.g., sleep-to-awake, awake-to-sleep, awake-to-suspend, different RRC states, etc.).

The activity may further be related to, updated based on, and/or adjusted to existing channel conditions.

Upon detecting a change in the energy profile (e.g., increase/decrease in energy harvesting rate, increase/decrease in energy consumption rate, etc.), the wireless device 22 is configured to signal/indicate an updated energy profile to the network node, which may be via implicit and/or explicit signaling, and/or may be via higher layer signaling and/or lower layer signaling.

In some embodiments, the energy harvesting configuration received by the wireless device 22 from the network node 16 is further based on at least one requirement/use case/etc. For example, a wireless device 22 which functions as an IoT thermometer (e.g., wireless device 22 includes sensors 85 for measuring ambient temperature) needs to collect x samples per day, which is configured by a client/remote server/etc.). This can also be done by a cloud, by a server in the cloud (e.g., host computer 24), and not necessarily by the network node 16 (e.g., by a gNB) itself, but by a network manager (e.g., Configuration unit 54) in the cloud server/host computer 24, in a core network 14 node, and/or any other kind of end receiver of information. For example, an energy harvesting wireless device 22 which functions as an outdoor thermometer (i.e., an IoT sensor) may have some predefined/configurable set of sensor requirements, e.g., the wireless device 22 may need to measure and/or report temperature readings once per day, twice per day, etc. These requirements which may be defined/based on an external server/client requesting certain features, e.g., via host computer 24.

In some embodiments, a method implemented in a network node 16 for communication with an energy harvesting wireless device 22 in a wireless network is provided. The method includes receiving an energy profile from the energy harvesting wireless device 22, determining a communication configuration based on the energy profile, signaling the communication configuration to the energy harvesting wireless device 22, and communicating with the energy harvesting wireless device 22 according to the signaled configuration.

In some embodiments, the communication configuration signaled to the energy harvesting wireless device 22 includes/modifies/updates one or more of a communication bandwidth (uplink and/or downlink bandwidth), a scheduling periodicity/timing (e.g., uplink and/or downlink scheduling), packet size(s), Discontinuous Reception (DRX)/Extension DRX (eDRX) periodicity/timing, measurement periodicity/timing, etc. For example, in a DRX (discontinuous receptions) configuration, the wireless device 22 can turn off its radio hardware (e.g., radio interface 82), and then may turn it on periodically, since the wireless device 22 is in an idle mode and/or sleep state. The wireless device 22 is configured (e.g., according to a DRX configuration) as to when to turn the radio interface 82 back on, at which time the wireless device 22 starts to listen to a paging signal. eDRX is similar to DRX, where eDRX allows for configuring longer periodicities than DRX. Some IoT wireless devices 22, for example, may have a use requirement that they last 10 years and thus there may be scenarios where such wireless device 22 may have relatively long sleep periods, e.g., only waking up once or twice per day, per week, etc. In between the wake-up instances, the wireless device 22 is not expected to maintain accurate timing/synchronization, and thus will need to perform some synchronization procedure(s) with the network node 16 before wireless device 22 starts to attempt to receive a paging signal or wakeup (WUP) signal.

With regard to measurement periodicity in the context of energy harvesting wireless devices 22, the wireless device 22 measures reference signals from the network node 16, and/or the network node 16 measures reference signaling from the wireless device 22. These measurements may be used for determining channel conditions, for connection/reconnection/handoff procedures, etc. Energy harvesting timing, as disclosed herein, may be a factor in determining measuring periodicity (as well as other measurement parameters) at the network node 16 and/or wireless device 22.

In some embodiments, the communication/configuration profile further depends on/may be updated based on estimated channel conditions to/from the energy harvesting device.

In some embodiments, the network node 16 or other server (e.g., host computer 24) in the network may predict/estimate/determine that the wireless device 22 energy harvesting configurations may need to be updated, and may signal/indicate/update such configurations accordingly. This prediction/estimation/determination may be based on implicit and/or explicit signaling from wireless device 22, and/or may be based on other information (e.g., publicly available weather data for the region/city/etc. in which the energy harvesting wireless device 22 is located, information received from or associated with a vehicle or premises in which wireless device 22 is located, information received from or associated with other wireless devices 22 in the wireless communication network, such as wireless devices 22 which are proximate to one another, etc.). For example, for a wireless device 22 which is attached to a rail locomotive and harvests vibrational energy when the locomotive is in motion, the configuration may be in part based on the schedule of the locomotive, e.g., the network node 16 knows when the locomotive is expected to be in motion (e.g., based on public rail schedule data), and therefore knows when the energy harvesting wireless device 22 is expected to be able to harvest energy, and may schedule/configure/etc. certain wireless device 22 activities/procedures accordingly. In some embodiments, the configuration may be based on historical energy harvesting and/or consumption information associated with wireless device 22 (e.g., the network node 16 learns from observation that wireless device 22 is most likely to harvest energy in the morning hours, and may schedule the wireless device 22 accordingly).

Some embodiments of the present disclosure may advantageously enable the network node 16 to efficiently initialize, configure, and communicate with an energy harvesting wireless device 22, and to update configurations/activities/procedures based on energy harvesting/consumption conditions and information. By knowing the energy harvesting and consumption information of an energy harvesting wireless device 22, the network node 16 may efficiently configure/update, for example, how frequently a wireless device 22 can be accessed, if and when a retransmission may take place, what capacity for measurements the wireless device 22 has, etc. Hence, the network node 16 may, e.g., avoid wasteful scheduling of the wireless device 22 when the wireless device 22 is not sufficiently charged/powered to be able to receive/transmit according to the schedule, or may avoid scheduling the device with more data than it is able to receive/transmit with its current charge/power. Furthermore, in case of an erroneously received or transmitted packet, the network node 16 and wireless device 22 may be configured for executing a retransmission in accordance with the energy harvesting and consumption information/state of the wireless device 22.

Embodiments of the present disclosure includes methods for determining, configuring, and communicating with a “zero-power” (i.e., very low power, relying on ambient/harvested energy, etc.), low-power, IoT, and/or energy harvesting wireless devices 22.

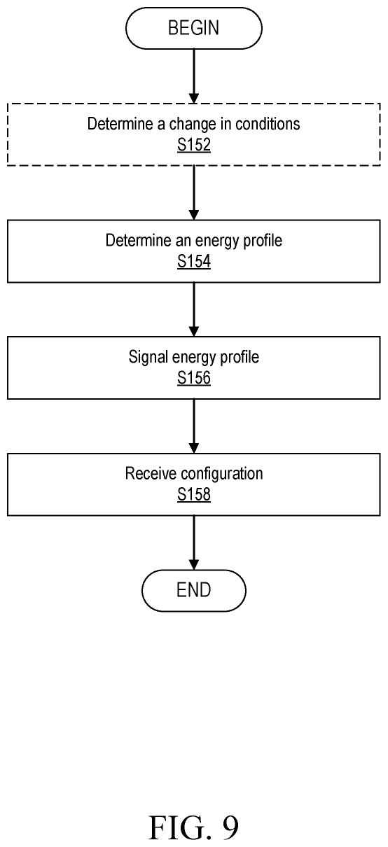

FIG. 9 is a flowchart which describes an example method in an energy harvesting wireless device 22 (or zero-power wireless device 22) for configuring the wireless device 22 for communicating with the network node 16, according to some embodiments of the present disclosure. In an optional step (Block S152), the wireless device 22 identifies a change in conditions. This may be related to the ability of the wireless device 22 to perform energy harvesting, or a need to change the communication type, e.g., the amount of data that is communicated or the frequency of such data or similar. Next (Block S154), the wireless device 22 determines an energy profile that the wireless device 22 operates with. Such an energy profile may contain an energy harvesting (or charging) profile and/or an energy consumption profile. The energy harvesting profile may include an amount of energy that is being harvested per time unit and/or a periodicity of the energy harvesting. For example, the energy harvesting profile may state that the wireless device 22 is able to continuously harvest 1 μW per time unit. In one embodiment, the energy harvesting profile is limited to the harvesting that is allocated to communication. In a related embodiment, the wireless device 22 may provide additional information regarding its harvesting capabilities, e.g., the wireless device 22 may indicate that it is capable of a first harvesting method (e.g., solar), a second harvesting method (e.g., vibrational), and so on. For example, each harvesting method can be one or more of wireless power harvesting, solar, wind, hydro, thermal, vibration, etc. In one embodiment, the wireless device 22 may further indicate the amount of potential harvesting energy per harvesting method, e.g., the wireless device 22 may indicate that it has the capability of the first harvesting method with 1 μW per time unit, and a second harvesting method with 2 μW per time unit.

In one embodiment, the energy harvesting profile is indicated as part of a capability signaling through higher layer signaling, e.g., RRC signaling, or as part of signaling over a PRACH when the wireless device 22 connects to the cell. Alternatively, or additionally, the wireless device 22 may be able to indicate its energy harvesting profile as part of a layer 1/layer 2 (L1/L2) signaling, e.g., assistance information, a specific L1 signaling, e.g., PUCCH, etc. A combination of above is also possible for signaling the energy harvesting profile, e.g., the wireless device 22 may indicate through higher layer signaling its capability regarding a first harvesting method, and a second harvesting method, and then use lower layer (e.g., L1/L2) signaling to dynamically indicate to the network node 16 the amount of potential harvested energy per harvesting method. For example, the wireless device 22 may initially indicate (e.g., via higher layer signaling) that it has the capability of wireless power harvesting and solar power harvesting as methods of harvesting, and then may use L1/L2 signaling in a first time instance (e.g., during the daytime) to indicate that, e.g., it can harvest 1 μW per time unit of wireless power, and 2 μW per time unit of solar power, and then in a second time instance (e.g., at night), it can indicate 1 μW per time unit of wireless power harvesting and 0 μW per time unit of solar power harvesting. In these examples, first and a second harvesting methods can be similar, e.g., a first wireless harvesting method, and a second wireless harvesting method, but may occur in different bands, e.g., different frequency bands such as 700 MHz, 2 GHZ, etc.

For example, in an embodiment in which wireless device 22 harvests solar energy, a clear summer day may present a different harvesting opportunity compared to a dark, cloudy winter day. As another example, a sensor which monitors vibrations in a wheel on a rail locomotive, and which is powered by harvesting vibrational energy from the wheels when they are in motion, may not be able to harvest energy when the locomotive is stationary. Thus, it may be beneficial for wireless device 22 to indicate to the network node 16 that it is in such a situation/environment.

In some embodiments, the core network 14 may be involved in configuring the wireless device 22 (e.g., as an alternative to network node 16, or in addition to network node 16). The core network 14 may directly or indirectly communicate with the wireless device 22, e.g., via NAS stratum signaling.

The energy consumption profile may include an amount of energy that is being consumed for tasks of the wireless device 22. Such tasks may involve fundamental wireless device 22 tasks such as operating in a certain state (e.g., deep sleep, light sleep, active, RRC_Connected/Idle/Inactive, etc.), transitioning to/from a certain state, or a sensing, actuating, or similar task that may be the main objective or purpose of the wireless device 22. Tasks may further involve communication tasks such as performing a transmission or reception of a packet of data, performing network measurements or network synchronization, etc. In one embodiment, the tasks are restricted to tasks related to communication. In one embodiment, the tasks are related to a specific channel condition, e.g., a reference channel condition or the present channel condition. The energy consumption profile may additionally indicate the amount of power which is available at the wireless device 22. The indication can be part of a capability signaling when the wireless device 22 access a new cell, e.g., RRC signaling, or it can be on a more dynamic way such as L1/L2 signaling as discussed in the examples above.

In one embodiment, the wireless device 22 may obtain the energy profile from reading a file or similar configuration information (e.g., stored in memory 88), whereas in another embodiment, the wireless device 22 may perform measurements (e.g., of the environment, of its own hardware 80, etc.) to determine the energy profile.

Still referring to FIG. 9, in an additional step (Block S156), the wireless device 22 signals a zero-power or energy harvesting capability/profile/etc. to the network node 16. Included in the capability, or signaled separately, is the energy profile of the wireless device 22. The energy profile may include the following sub-profiles/information.

Energy harvesting information, e.g., harvested energy per time unit, harvesting method, and harvesting pattern, e.g., periodic harvesting, etc.; and

Energy consumption information related to activities of the wireless device 22, including defined network tasks, e.g., network synchronization, data transmissions and reception, measurements, cell reselection, as well as general wireless device 22 energy consumption, e.g., wireless device 22 state (deep sleep, light sleep, awake) and state transitions, and sensor, actuator or similar energy consumption information associated with the wireless device 22 and hardware 80, etc.

The energy profiles may be provided as a predefined profile among a set of predefined profiles, in which case the chosen profile may be the profile that fits closest to the actual wireless device 22 profile or a profile that is less demanding compared to another wireless device 22 profile.

The wireless device 22 may further adjust the energy profile to suit current channel conditions. For example, a poor channel will require a higher transmit power, implying more energy will be consumed during transmission compared to a reference. In this case, for example, additional energy harvesting time may be required to accumulate enough power to transmit at the higher transmit power, and network node 16 may modify/update one or more wireless device 22 activity/procedure (e.g., periodicity/timing, packet size, coding, bandwidth, modulation etc.), to accommodate the required higher transmit power and longer energy harvesting times.

Still referring to FIG. 9, in a subsequent step (Block S158), the wireless device 22 receives a configuration message from the network node 16, configuring/updating the wireless device 22 to operate according to the provided configuration. The term “operate”, in this context, may include adjusting/updating/configuring one or more wireless device 22 activities/procedures, for example, adjusting communication periodicity, C-DRX configuration, DRX or eDRX periods, preconfigured uplink (UL) or downlink (DL) resource configurations, specific wireless device 22 power saving techniques (e.g., wake-up signaling, packet size, retransmission scheme, whether further harvesting is required prior to transmitting or receiving a retransmission), cell-reselection/RRM measurements (e.g., providing criteria to relax such measurements), beam configurations, etc. The configuration message can additionally indicate to the wireless device 22 the type of harvesting method that the wireless device 22 should use until the next network node 16 indication is received, and/or upon expiry of a validity timer (which may be signaled by the network node 16 or preconfigured in the wireless device 22).

Still referring to FIG. 9, the above steps may also be performed after an initial configuration, in which case the optional step (Block S152) may precede the first step (Block S154). In the optional step, the wireless device 22 identifies a change in conditions. This may be related to the ability of the wireless device 22 to perform energy harvesting, or a need to change the communication type, e.g., the amount of data that is communicated or the frequency of such data or similar.

In another embodiment, the wireless device 22 harvesting configuration may contain a temporal aspect/timing information/scheduling information/etc., for instance, indicating an inability of the wireless device 22 to harvest energy during nights, less ability to harvest energy during winter and cloudy weather conditions, etc., and configuring/updating the wireless device 22 accordingly.

In another embodiment, the wireless device 22 may update its harvesting capability due to a temporary or permanent malfunction of a harvesting source/device (e.g., energy harvester 35). For example, an energy harvester 35 component responsible for vibration energy harvesting may malfunction, while a solar cell is still functional, and wireless device 22 and/or network node 16 may update the wireless device 22 energy configuration accordingly (e.g., by reducing power consumption in view of the reduction in energy harvesting).

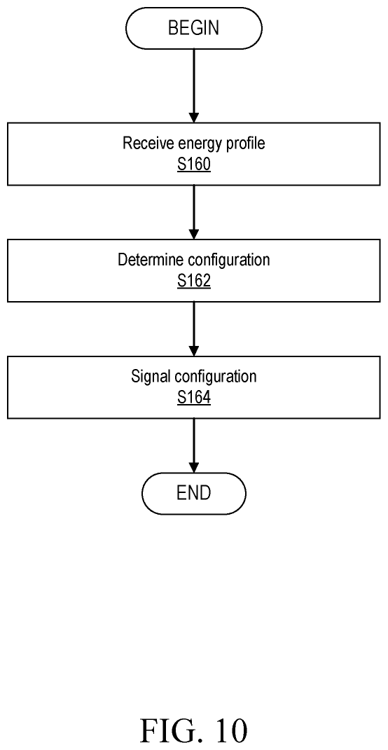

Referring to FIG. 10, in another aspect of the present disclosure, a network node 16 configures a zero-power or energy harvesting wireless device 22 for communication according to the energy harvesting and consumption capabilities of the wireless device 22. In a first step (Block S160), the network node 16 receives a capability report from the wireless device 22. Included in the capability report, or provided separately to the network node 16, may be an energy profile, including an energy harvesting profile and an energy consumption profile, as described above with respect to the wireless device 22.

In a second step (Block S162), the network node 16 determines a communication configuration for the wireless device 22, based on the energy profile. This step is also similar to what is described above with respect to the wireless device 22 operation. The network node 16 may further adjusts the configuration of the wireless device 22, e.g., based on the specific channel conditions of the wireless device 22. In a third step (Block S164), the network node 16 transmits the configuration to the wireless device 22 making it possible for the wireless device 22 to properly operate in the network in accordance with its energy harvesting and consumption capabilities/states. For example, the configuration provision can be provided via one or more of higher layer signaling, e.g., RRC signaling, via system information updates, through system information block messages (SIBn)), via layer 2 (L2) signaling, e.g., medium access control/control element (MAC CE) signaling, via layer 1 (L1) signaling, e.g., downlink control indicator (DCI) signaling, etc.

In another embodiment the network node 16 may autonomously (e.g., without requiring explicit administrator/user input and/or without requiring explicit signaling from the wireless device 22) predict a lower capability of the wireless device 22 to harvest energy, for instance, during nights, during winter conditions, while stationary, etc.

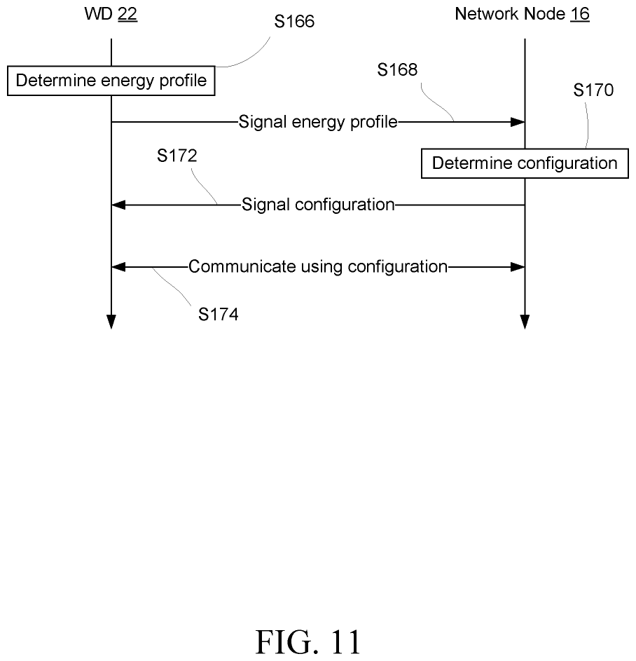

FIG. 11 depicts a signaling diagram of communication between a between a zero-power/energy harvesting wireless device 22 and a network node 16 based on an energy configuration, in accordance with some embodiments of the present disclosure. In a first step (S166), the wireless device 22 determines an energy profile, as described herein. In a second step (S168), the wireless device 22 signals its energy profile to the network node 16. In a third step (S170), the network node 16 determines an energy configuration for the wireless device 22 based on the received energy profile, as described herein. In a fourth step (S172), the network node 16 signals the energy configuration to the wireless device 22. In a fourth step (S174), the wireless device 22 communicates with network node 16 in accordance with the energy configuration, as described herein.

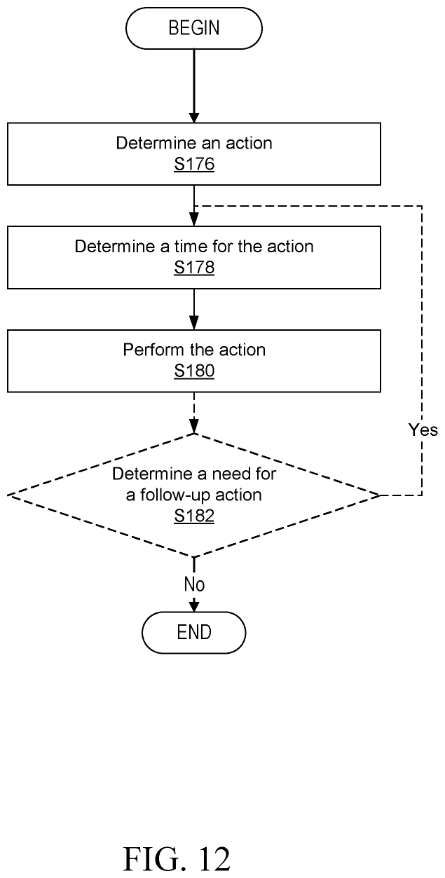

FIG. 12 depicts a flowchart describing communication between a zero-power/energy harvesting wireless device 22 and a network node 16 based on the provided configuration, in accordance with some embodiments of the present disclosure. In a first step (Block S176), either the wireless device 22 or the network node 16 determines that an action is required, e.g., the wireless device 22 determines it needs to transmit a packet to the network node 16. This may be due to the wireless device 22 having recorded some data (e.g., sensor data) and needing to transmit the data via the network node 16 to an end server or to a cloud server (e.g., host computer 24), e.g., according to a preconfigured sensor data reporting periodicity.

Referring still to FIG. 12, in a second step (Block S178), the wireless device 22 determines a time/timing/periodicity/schedule for the action based on the configuration of the wireless device 22 as received and determined by network node 16. Since both the wireless device 22 and network node 16 share this configuration (i.e., both wireless device 22 and network node 16 know at least some of the parameters of the configuration), it may be possible for both entities to know when a certain activity may take place and may therefore also prepare for it. This may occur regardless of whether the wireless device 22 or the network node 16 initializes the action. In a third step (Block S180), the wireless device 22 (and/or network node 16) performs the action according to predefined configuration, possibly including any time and frequency resources that are allocated to the wireless device 22 to perform the action. Alternatively, the action may be to request resources. In an optional fourth step (Block S182), if the action may have a follow-up action, the wireless device 22 may determine a need for such a follow-up action. Examples of a follow-up action may be to receive a scheduling grant upon transmitting a scheduling request, to transmit a data packet upon receiving a scheduling grant, to perform a retransmission in case a packet was not properly received and acknowledged, etc. If so, the flow returns to Block S178.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-37. (canceled)

38. A method implemented in a wireless device configured to communicate with a network node of a wireless communication network, the method comprising:
selecting a first energy profile of the wireless device;
transmitting to the network node a first indication indicating the first energy profile;
receiving a first energy configuration from the network node, the first energy configuration being received in response to the first indication indicating the first energy profile;
updating at least one wireless device activity in response to the received first energy configuration; and
communicating with the network node in response to the updated at least one wireless device activity.

39. The method of claim 38, wherein the at least one wireless device activity includes one or more of:
an initial access procedure;
a network synchronization procedure;
a cell reselection procedure;
a beamforming procedure;
a data transmission procedure;
a data reception procedure;
a measurement procedure;
a sleep procedure;
a discontinuous reception procedure;
a state transition procedure; and
a sensor procedure.

40. The method of claim 38, wherein the first energy profile includes an energy harvesting profile, the energy harvesting profile indicating one or more of:
an energy harvesting source type of the wireless device;
an energy harvesting rate of the wireless device;
an energy harvesting schedule of the wireless device;
an energy harvesting time duration of the wireless device;
an energy storage amount of the wireless device; and
an energy storage capacity of the wireless device.

41. The method of claim 38, wherein the first energy profile includes an energy consumption profile, the energy consumption profile indicating a mapping of the at least one wireless device activity to at least one corresponding energy consumption rate; and
the updating of the at least one wireless device activity being performed in reaction to the at least one corresponding energy consumption rate.

42. The method of claim 38, wherein the updating of the at least one wireless device activity is performed in reaction to at least one channel condition associated with the wireless device.

43. The method of claim 38, wherein the updating of the at least one wireless device activity includes restricting at least one of transmissions and receptions of at least one non-essential transmission type during at least one time period, the at least one time period being associated with a low energy harvesting rate of the wireless device.

44. The method of claim 38, wherein the updating of the at least one wireless device activity includes scheduling transitions between a sleep state and an active state of the wireless device in reaction to a predicted energy harvesting rate of the wireless device.

45. The method of claim 44, wherein the predicted energy harvesting rate of the wireless device is dependent on weather information associated with a location of the wireless device.

46. The method of claim 38, wherein the first energy configuration indicates at least one of:
a communication bandwidth;
a scheduling periodicity;
a packet size;
a discontinuous reception periodicity; and
a measurement periodicity.

47. The method of claim 38, further comprising:
detecting a change of an energy state of the wireless device;
updating an energy profile in response to the detected change of the at least one energy state;
transmitting to the network node a second indication indicating the updated energy profile, the updated energy profile being different from the first energy profile;
receiving an updated energy configuration from the network node in response to the updated energy profile; and
modifying at least one of the at least one wireless device activities in response to the updated energy configuration.

48. The method of claim 38, wherein the transmission of the first indication indicating the first energy profile includes:
at least one energy harvesting type indication and
at least one energy harvesting rate indication, the at least one energy harvesting rate indication being associated with one of the at least one energy harvesting type indication.

49. The method of claim 38, wherein the method further comprises:
selecting at least one updated energy harvesting rate associated with at least one energy harvesting type; and
transmitting a second indication to the network node, the second indication indicating the at least one updated energy harvesting rate.

50. The method of claim 38, wherein the energy profile indicates a malfunctioning energy harvesting type and at least one non-malfunctioning energy harvesting type.

51. A method implemented in a network node configured for operation in a wireless communication network, wherein the network node is configured to communicate with a wireless device and the method comprises:
receiving, from the wireless device, a first indication indicating a first energy profile of the wireless device;
selecting a first energy configuration based on the first indication indicating the first energy profile;
transmitting the energy configuration to the wireless device for updating at least one wireless device activity in response to the first energy configuration; and
communicating with the wireless device in response to the updated at least one wireless device activity.

52. The method of claim 51, further comprising:
receiving a second indication indicating an updated energy profile of the wireless device, the updated energy profile including at least one parameter different from the first energy profile;
selecting an updated energy configuration based on the updated energy profile; and
transmitting the updated energy configuration to the wireless device for modifying at least one of the at least one wireless device activities in response to the updated energy configuration received.

53. The method of claim 51, wherein the receiving of the first indication indicating the first energy profile includes:
at least one energy harvesting type indication and
at least one energy harvesting rate indication received, each the at least one energy harvesting rate indication being associated with one of the at least one energy harvesting type indication.

54. The method of claim 51, wherein the method further comprises:
receiving a second indication via lower layer signaling from the wireless device, the second indication indicating at least one updated energy harvesting rate associated with the at least one energy harvesting;
selecting a modified energy configuration in response to the received second indication; and
transmitting the modified energy configuration to the wireless device.

55. The method of claim 51, wherein the energy profile indicates a malfunctioning energy harvesting type and at least one non-malfunctioning energy harvesting type.

56. A wireless device comprising:
a radio interface configured for communicatively coupling the wireless device with a wireless communication network; and
processing circuitry operatively associated with the radio interface and configured to:
select a first energy profile of the wireless device;
transmit to a network node of the wireless communication network, a first indication indicating the first energy profile;
receive a first energy configuration from the network node, the first energy configuration being received in response to the first indication indicating the first energy profile;
update at least one wireless device activity in response to the received first energy configuration; and
communicate with the network node in response to the updated at least one wireless device activity.

57. The wireless device of claim 56, wherein the at least one wireless device activity includes one or more of:
an initial access procedure;
a network synchronization procedure;
a cell reselection procedure;
a beamforming procedure;
a data transmission procedure;
a data reception procedure;
a measurement procedure;
a sleep procedure;
a discontinuous reception procedure;
a state transition procedure; and
a sensor procedure.

58. The wireless device of claim 56, wherein the first energy profile includes an energy harvesting profile, the energy harvesting profile indicating one or more of:
an energy harvesting source type of the wireless device;
an energy harvesting rate of the wireless device;
an energy harvesting schedule of the wireless device;
an energy harvesting time duration of the wireless device;
an energy storage amount of the wireless device; and
an energy storage capacity of the wireless device.

59. The wireless device of claim 56, wherein the first energy profile includes an energy consumption profile, the energy consumption profile indicating a mapping of the at least one wireless device activity to at least one corresponding energy consumption rate; and
the updating of the at least one wireless device activity being performed in reaction to the at least one corresponding energy consumption rate.

60. The wireless device of claim 56, wherein the processing circuitry is further configured to:
detect a change of an energy state of the wireless device;
update an energy profile in response to the detected change of the at least one energy state;
transmit to the network node a second indication indicating the updated energy profile, the updated energy profile being different from the first energy profile;
receive an updated energy configuration from the network node in response to the updated energy profile; and
modify at least one of the at least one wireless device activities in response to the updated energy configuration.

61. The wireless device of claim 56, wherein the processing circuitry is further configured to:
select at least one updated energy harvesting rate associated with at least one energy harvesting type; and
transmit a second indication via lower layer signaling to the network node, the second indication indicating the at least one updated energy harvesting rate.

62. The wireless device of claim 56, wherein the energy profile indicates a malfunctioning energy harvesting type and at least one non-malfunctioning energy harvesting type.

63. A network node configured for operation in a wireless communication network, the network node comprising:
a communication interface; and
processing circuitry operatively associated with the communication interface and configured to:
receive, from a wireless device associated with the wireless communication network, a first indication indicating a first energy profile of the wireless device;
select a first energy configuration based on the first indication indicating the first energy profile;
transmit the energy configuration to the wireless device for updating at least one wireless device activity in response to the first energy configuration; and
communicate with the wireless device in response to the updated at least one wireless device activity.

64. The network node of claim 63, wherein the processing circuitry is configured to update the at least one wireless device activity includes scheduling transitions between sleep and active states of the wireless device in response to a predicted energy harvesting rate of the wireless device.

65. The network node of claim 63, wherein the first indication indicating the first energy profile includes:
at least one energy harvesting type indication and
at least one energy harvesting rate indication, each the at least one energy harvesting rate indication being associated with one of the at least one energy harvesting type indication.

66. The network node of claim 63, wherein the processing circuitry is further configured to:
receive a second indication from the wireless device, the second indication indicating at least one updated energy harvesting rate associated with the at least one energy harvesting;
select a modified energy configuration in response to the received second indication; and
transmit the modified energy configuration to the wireless device.

67. The network node of claim 63, wherein the energy profile indicates a malfunctioning energy harvesting type and at least one non-malfunctioning energy harvesting type.
